(19) United States
(12) Patent Application Publication
(10) Pub. No.: US 2007/0059974 A1
(43) Pub. Date: Mar. 15, 2007

(54) Connector having lighting apparatus

(75) Inventors: Chih-Tse Chen, Taoyuan Hsien (TW); Ching-Man Kao, Taoyuan Hsien (TW); Han-Cheng Hsu, Taoyuan Hsien (TW); Chung-Jung Kuo, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/378,468

(22) Filed: Mar. 20, 2006

(30) Foreign Application Priority Data
Sep. 9, 2005 (TW) 94215499

(51) Int. Cl. H01R 3/00

(52) U.S. Cl. 439/489

(57) ABSTRACT

A connector having at least one lighting apparatus is disclosed. The lighting apparatus, such as an LED, includes a lighting portion and two pins. Each of the two pins comprises at least one bent portion. The two pins project from the same surface of the lighting portion. At least one of the pins further comprises an inclined portion for preventing pins contact in the connector.

### BACKGROUND OF THE INVENTION

1. Field of the Invention

The invention relates in general to a connector and in particular to a connector having lighting apparatuses.

2. Description of the Related Art

A conventional lighting apparatus, such as an LED 100 as shown in FIG. 1, comprises a lighting portion 101 and two pins 102, 102′. The pins 102, 102′ project from the same surface of the lighting portion 101, perpendicular or parallel to the lighting portion 101. Each of the pins 102, 102′ has at least one bent portion 103. Generally, the two pins 102 and 102′ are welded to an electronic device (not shown) and used as electrical conducting pins with different polarities.

Traditionally, a pair of conventional LEDs 100 and 100′ are applied in a RJ-45 connector 200, as shown in FIG. 2. Elements corresponding to those of FIG. 1 share the same reference numerals, and explanation thereof is omitted for simplification of the description. In FIG. 2, as the LEDs 100 and 100′ are disposed in the RJ-45 connector 200, the bent portions 103 of the two LEDs 100 and 100′ may contact each other and lead to a broken circuit due to the short distance therebetween on the same plane. Moreover, it is difficult to separate the bent portions 103 from each other to a safe distance owing to the size limitation of the connector.

### BRIEF SUMMARY OF INVENTION

To eliminate the disadvantages of conventional connectors having lighting apparatuses, the invention provides a lighting apparatus comprising a lighting portion and two pins projecting from the same surface of the lighting portion. Specifically, each of the two pins comprises at least one bent portion, and at least one of the pins further comprises an inclined portion. The inclined portion prevents the lighting apparatus from shorting resulting from the contact between the two pins.

The invention further provides a connector, such as a RJ-45 connector, comprising a housing and two lighting apparatuses. The housing has a recess for the two lighting apparatuses being disposed therein, wherein the recess has an inclined surface. Each of the lighting apparatuses comprises a lighting portion and two pins. Each of the pins has at least one bent portion, and at least one of the pins further comprises an inclined portion which is correspondingly disposed on the inclined surface.

The lighting apparatus can be an LED. Further, the lighting portion can be a transparent body and comprises a fluorescent material. The pins project from the same surface of the lighting portion. The pins are welded to an electronic device and used as electrical conducting pins with different polarities.

With the particular design of the inclined portions of the lighting apparatuses, pins of different lighting apparatuses can prevent contact with each other, and pins contact of a single lighting apparatus can be also avoided.

### BRIEF DESCRIPTION OF DRAWINGS

The invention can be more fully understood by reading the subsequent detailed description and examples with references made to the accompanying drawings, wherein:

FIG. 1 is a perspective diagram of a conventional LED;

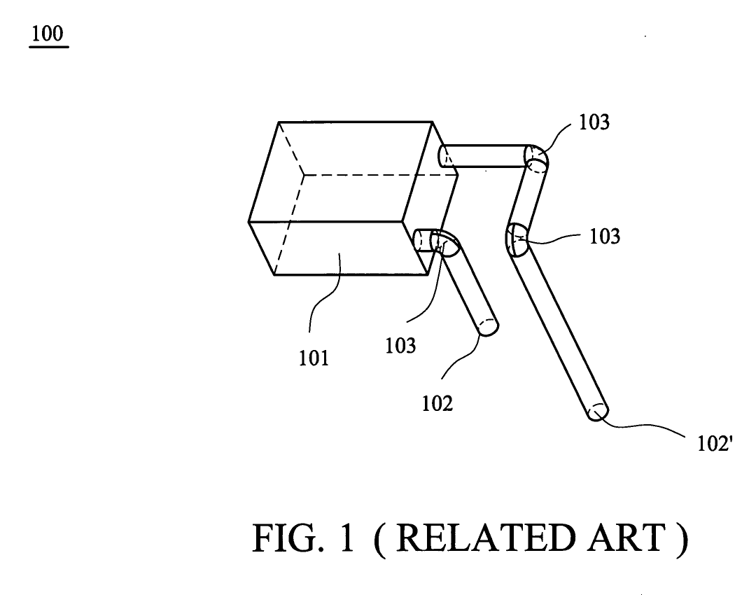

FIG. 2 is a perspective diagram of a conventional RJ-45 connector with LEDs;

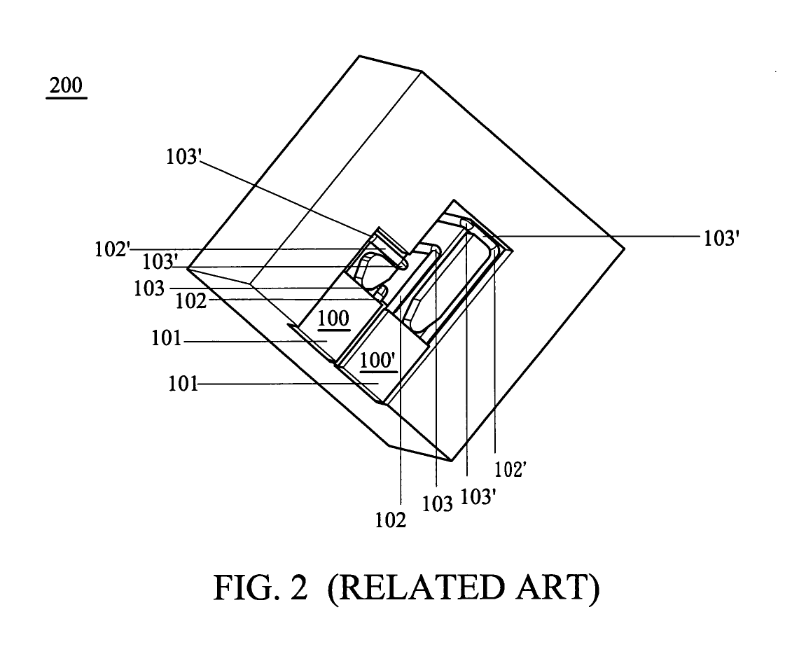

FIG. 3 is a perspective diagram of an embodiment of a lighting apparatus;

FIG. 4A is a perspective diagram of an embodiment of a connector having lighting apparatuses; and

FIG. 4B is a perspective diagram of the lighting apparatuses in FIG. 4A.

### DETAILED DESCRIPTION OF INVENTION

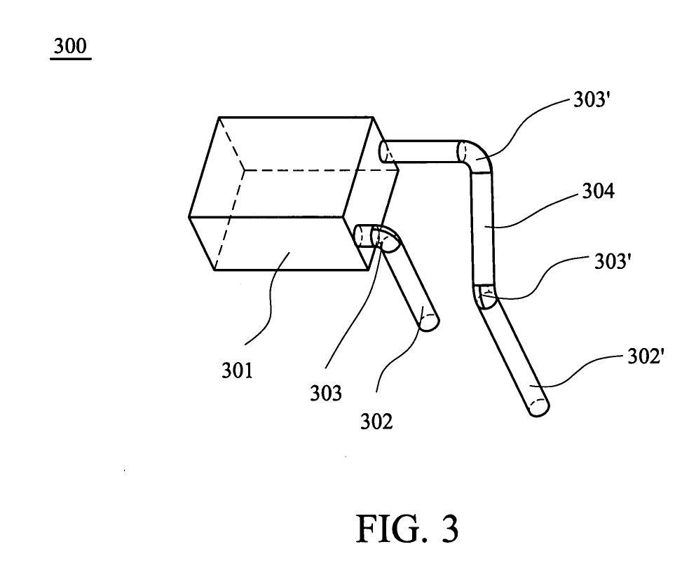

Referring to FIG. 3, a lighting apparatus 300 comprises a lighting portion 301 and two pins 302 and 302′ projecting from the same surface of the lighting portion 301. Each of the two pins 302 and 302′ comprises at least one bent portion 303 and 303′, wherein the pin 302′ further comprises an inclined portion 304.

The two pins 302 and 302′ are welded to an electronic device and used as electrical conducting pins with different polarities. The lighting portion 301 is a transparent body and comprises a fluorescent material. The lighting apparatus 300, such as an LED, can be applied in a connector, such as a RJ-45 connector. In this embodiment, contact between pins 302 and 302′ is avoided due to the inclined portion 304, thereby preventing the lighting apparatus 300 from shorting.

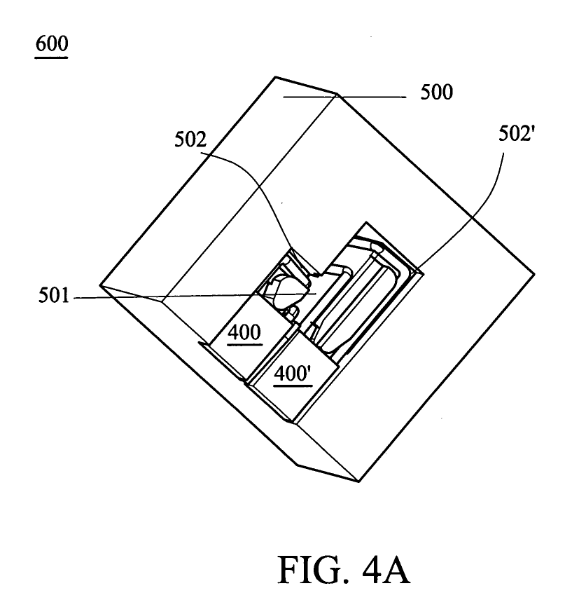

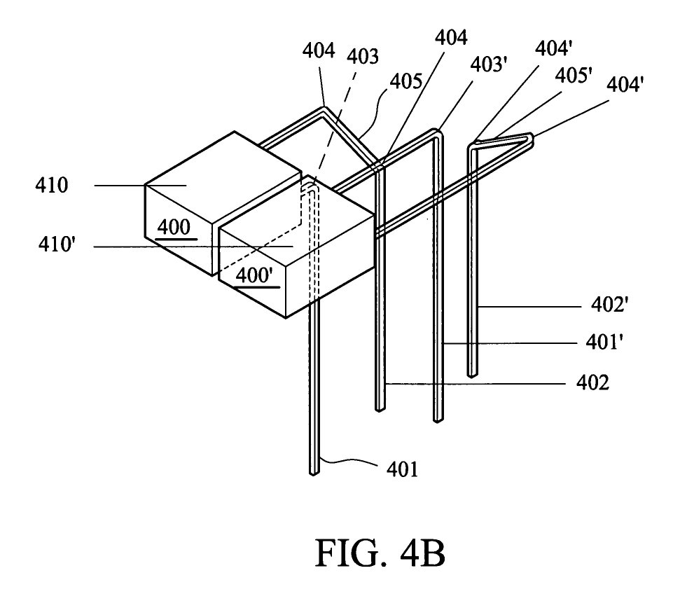

FIG. 4A shows an embodiment of a connector having lighting apparatuses. The connector 600, such as a RJ-45 connector, comprises a housing 500 and two lighting apparatuses 400 and 400′. The housing 500 comprises a recess 501 for the lighting apparatuses 400 and 400′ being disposed therein. Specifically, the recess 501 has two inclined surfaces 502 and 502′.

FIG. 4B shows the lighting apparatuses 400 and 400′ in FIG. 4A. As shown in FIG. 4B, the lighting apparatus 400 comprises a lighting portion 410 and two pins 401 and 402. Each of the two pins 401 and 402 comprises a bent portion 403 and 404, respectively, wherein the pin 402 further comprises an inclined portion 405. The lighting apparatus 400′ comprises a lighting portion 410′ and two pins 401′ and 402′. Each of the two pins 401′ and 402′ comprises a bent portion 403′ and 404′, respectively, wherein the pin 402′ further comprises an inclined portion 405′. The inclined portions 405 and 405′ are correspondingly disposed on the inclined surfaces 502 and 502′ in FIG. 4A.

In this embodiment, the lighting apparatuses 400 and 400′ are LEDs. The lighting-portions 410 and 410′ are transparent-bodies, respectively and comprise fluorescent materials. The two pins 401 and 402 project from the same surface of the lighting portion 410, and correspondingly, the two pins 401′ and 402′ project from the same surface of the lighting portion 410′. The pins 401, 402, 401′ and 402′ are welded to an electronic device, wherein the pins 401 and 402 are used as electrical conducting pins with different polarities, and correspondingly, the pins 401′ and 402′ are used as electrical conducting pins with different polarities.

According to this embodiment, contact between pins 402 and 401′ is avoided owing to the staggered arrangement of the inclined portion 405, thus preventing shorting of the two lighting apparatuses 400 and 400′. Further, shorting from the contact of the pins 401′ and 402′ in the same lighting apparatus 400′ is also avoided by the staggered arrangement of the inclined portion 405′.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A lighting apparatus comprising:
a lighting portion, and
two pins, each comprising a bent portion, wherein at least one of the two pins comprises an inclined portion.

2. The lighting apparatus as claimed in claim 1, wherein the two pins project from the same surface of the lighting portion.

3. The lighting apparatus as claimed in claim 1, wherein the two pins are welded to an electronic device.

4. The lighting apparatus as claimed in claim 1, wherein the two pins are electrical conducting pins with different polarities.

5. The lighting apparatus as claimed in claim 1, wherein the lighting portion is a transparent body.

6. The lighting apparatus as claimed in claim 1, wherein the lighting portion comprises a fluorescent material.

7. The lighting apparatus as claimed in claim 1, wherein the lighting apparatus is disposed in a connector.

8. The lighting apparatus as claimed in claim 7, wherein the connector is a RJ-45 connector.

9. A connector comprising:
a housing comprising a recess; and
at least one lighting apparatus having a plurality of pins and disposed in the recess, wherein the recess comprises at least one inclined surface for at least one of the pins being disposed thereon.

10. The connector as claimed in claim 9, wherein the lighting apparatus comprises a lighting portion and two pins, each of the pins comprises at least one bent portion, and at least one of the two pins further comprises an inclined portion corresponding to the inclined surface.

11. The connector as claimed in claim 10, wherein the two pins project from the same surface of the lighting portion.

12. The connector as claimed in claim 10, wherein the two pins are welded to an electronic device.

13. The connector as claimed in claim 10, wherein the two pins are electrical conducting pins with different polarities.

14. The connector as claimed in claim 10, wherein the lighting portion is a transparent body.

15. The connector as claimed in claim 10, wherein the lighting portion comprises a fluorescent material.

16. The connector as claimed in claim 10, wherein the connector is a RJ-45 connector.
